(19) United States
(12) Patent Application Publication
(10) Pub. No.: US 2004/0028047 A1
(43) Pub. Date: Feb. 12, 2004

(54) Switch for local area network

(76) Inventors: Sean Hou, Santa Clara, CA (US); William R. Ge, Mountain View, CA (US); Daniel Yin Yung Ching, San Jose, CA (US); Keith M. Andrews, Lathrop, CA (US); Christopher H. Claudatos, San Jose, CA (US); Magnus B. Hansen, Fremont, CA (US)

Correspondence Address: FISH & RICHARDSON P.C., 500 ARGUELLO STREET, SUITE 500, REDWOOD CITY, CA, 94063, US

(21) Appl. No.: 10/445,293

(22) Filed: May 22, 2003

Related U.S. Application Data
(60) Provisional application No. 60/382,730, filed on May 22, 2002.

(51) Int. Cl. H04L 12/56

(52) U.S. Cl. 370/392

(57) ABSTRACT

Methods and apparatus, including computer program products, implement techniques for processing data packets in a computer network. A packet filter engine is configured to process data packets at wire-speed based on or more user defined packet policies. A received data packet is examined to determine if there is a match between the data packet and one or more packet policies. If no matching packet policies are found, the packet is routed. If a matching packet policy is found, the data packet is processed based on the policy action fields of the matching policy.

### CROSS-REFERENCE TO RELATED APPLICATIONS

This application claims priority based on U.S. provisional application serial No. 60/382,730, filed May 22, 2002, the disclosure of which is incorporated here by reference in its entirety.

### BACKGROUND

This invention relates to network switching, and more particularly to Layer 2 through Layer 7 switching.

The OSI (Open System Interconnection) Model is an ISO standard for worldwide communications that defines a networking framework for implementing protocols in seven layers. Control is passed from one layer to the next, starting at the applications layer in one station, and proceeding to the physical layer and back up the hierarchy.

The layers are defined as:

Applications Layer 7 provides interface to end-user processes and standardized services to applications.

Presentation Layer 6 specifies architecture-independent data transfer format, encodes and decodes data, encrypts and decrypts data, compresses data.

Session Layer 5 manages user sessions and reports upper-layer errors.

Transport Layer 4 manages network layer connections and provides reliable packet delivery mechanism.

Network Layer 3 addresses and routes packets.

Data Link Layer 2 frames packets and controls physical layer data flow.

Physical Layer 1 interfaces between network medium and network devices. Also defines electrical and mechanical characteristics.

### SUMMARY OF THE INVENTION

In general, in one aspect, the invention provides method and apparatus, including computer program products, for processing data packets in a computer network, the data packets including information from one or more of Layers 2 through 7 of the OSI model. The method includes configuring a packet filter engine to process data packets at wire-speed based on one or more user defined packet policies, each user defined packet policy specifying information for one or more of Layers 4 through 7, receiving a data packet having a sequence of bytes, examining the data packet, and determining if there is a match between the data packet and one or more of the packet policies, each packet policy having on or more policy action fields. The method includes routing the data packet if no matching packet policy is found, and processing the data packet based on the policy action fields of the matching policy if a matching packet policy is found.

Advantageous implementations of the invention include one or more of the following features. Configuring the packet filter engine can include receiving a user request for a packet policy, and transmitting the requested packet policy to the packet filter engine as one of the one or more user defined packet policies. Each user defined packet policy can specify a policy byte pattern and determining if there is a match can include determining if the sequence of bytes in the received packet matches the policy byte pattern. Routing the packet can include routing the packet using a Layer 2-3 switch. The policy action field can specify an action to be performed on the received data packet and processing the packet can include performing the specified action in the policy action field. Processing the packet can include blocking the packet based on the policy action field of the matching policy, forwarding the data packet to one or more switch applications, and processing the data packet using a switch application of the one or more switch applications. The switch applications can include applications for performing network address translation and applications for detecting attempted network security attacks. The packet policies can include predefined packet policies or user-specified expert policies. The method can also include receiving a user request to disable a deactivated packet policy of the one or more user defined packet policies, and configuring the packet filter engine to disable the deactivated packet policy. The method can also include specifying for one or more of the packet policies, at least one of a start time and an end time, obtaining a current time, and if a start time and an end time are specified, determining there is a match when the current time is within a duration starting at the start time and ending at the end time. If the end time is not specified, determining if there is a match can include determining there is a match when the current time is greater than the start time. If the start time is not specified, determining if there is a match can include determining there is a match when the current time is less than the end time.

In another aspect, the invention is directed to a method for receiving a request at a first network switch to transfer switch data from the first network switch to a second network switch, the switch data being operable to control operation of the first network switch and the second network switch, and transferring the switch data from the first network switch to the second network switch. The switch data can include configuration data or firmware for the network switch.

In another aspect, the invention is directed to an apparatus for processing data packets. The apparatus includes a packet policy repository, a time triggered action unit, a packet filter engine, and a packet policy manager. The packet policy repository contains one or more requested packet policies, each requested packet policy having a policy byte pattern and one or more policy action fields. The time triggered action unit is operable to specify at least one of a start time and an end time associated with a requested packet policy of the one or more requested packet policies, generating a start time trigger event if the start time is specified, generating an end time trigger event if the end time is specified. The packet filter engine applies one or more activated packet policies for each received packet at wire-speed. The packet filter engine is also operable to detect received packets matching an activated packet policy of the one or more activated packet policies, and process the packet according to the policy action fields of the matching packet policy. The packet policy manager detects the start time trigger event and adds the associated requested packet policy to the one or more activated packet policies applied by the packet filter engine. The packet policy manager alos detects the end time trigger event and deletes the associated requested packet policy from the one or more activated packet policies applied by the packet filter engine.

Advantageous implementations of the invention can include one or more of the following features. The user can specify one or more user defined policies using the packet policy manager, and the user defined policies can be stored as requested packet policies in the packet policy repository.

In another aspect the invention is directed to an apparatus for processing data packets comprising a plurality of network switches, each network switch including a central management unit, the central management unit including a central management client and a central management server. A first network switch is operable to transfer data from the first network switch to a second network switch, and the third network switch is operable to receive requests from the user for a transfer of switch data from the first network switch to the second network switch. The third network switch configures the first network switch and the second network switch to complete the transfer of data requested by the user, the switch data being operable to control the operation of the first network switch and the second network switch. The switch data can include configuration data or firmware for the network switch.

The invention can be implemented to realize one or more of the following advantages. A switch that allows a network administrator to route Layer 2 or Layer 3 packets based on the information obtained Layer 2 through Layer 7 provides the network administrator with very precise control over network traffic flows and bandwidth consumption in the network. The network administrator can use the Layer 2-7 information to block data packets associated with specific applications. The network administrator can also use the Layer 2-7 information to route packets associated with specific applications with a higher priority or to allocate a fixed percentage of the available bandwidth to specific applications. The network administrator can use the Layer 2-7 information to identify data packets to be cloned and use the cloned data packets for surveillance. The network administrator can also user the Layer 2-7 information to identify data packets to be redirected to a different destination or to be quarantined. One implementation of the invention provides all of the above advantages.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 shows a network topology including a multilayer switch.

FIG. 2A shows a block diagram of an exemplary implementation of the switch.

FIG. 2B is a block diagram illustrating an alternative switch implementation including a time triggered action unit (TTA).

FIG. 2C is a block diagram of an implementation of the switch including a central management unit (CMU).

FIG. 3 is a block diagram illustrating the components of a packet policy.

FIG. 4 is a block diagram illustrating the types of packet policies that may be requested by the user.

FIG. 5 is a block diagram illustrating a method of operation of the packet filter engine.

FIG. 6 is a block diagram illustrating the components of a timed policy request to be processed by the TTA.

FIG. 7 is a flow diagram illustrating a method of processing a timed policy request.

FIG. 8 is a flow diagram illustrating activation of a packet policy scheduled using a timed policy request.

FIG. 9 is a block diagram illustrating a CMU.

FIG. 10 illustrates an exemplary user interface for the CMU.

FIG. 11 is a flow diagram illustrating a method for transferring data using the central management client.

FIG. 12 is a flow diagram illustrating a method for transferring data using the central management server.

FIG. 13A illustrates an exemplary user interface for specifying requested packet policies to be implemented by the switch.

FIG. 13B illustrates the use of the main service menu to specify the type of packets to be filtered using the requested packet policy.

FIG. 13C illustrates the use of the action value fields to specify the policy action fields.

FIG. 14 illustrates an exemplary user interface operable by the user to specify expert packet policies.

Like reference numbers and designations in the various drawings indicate like elements.

### DETAILED DESCRIPTION

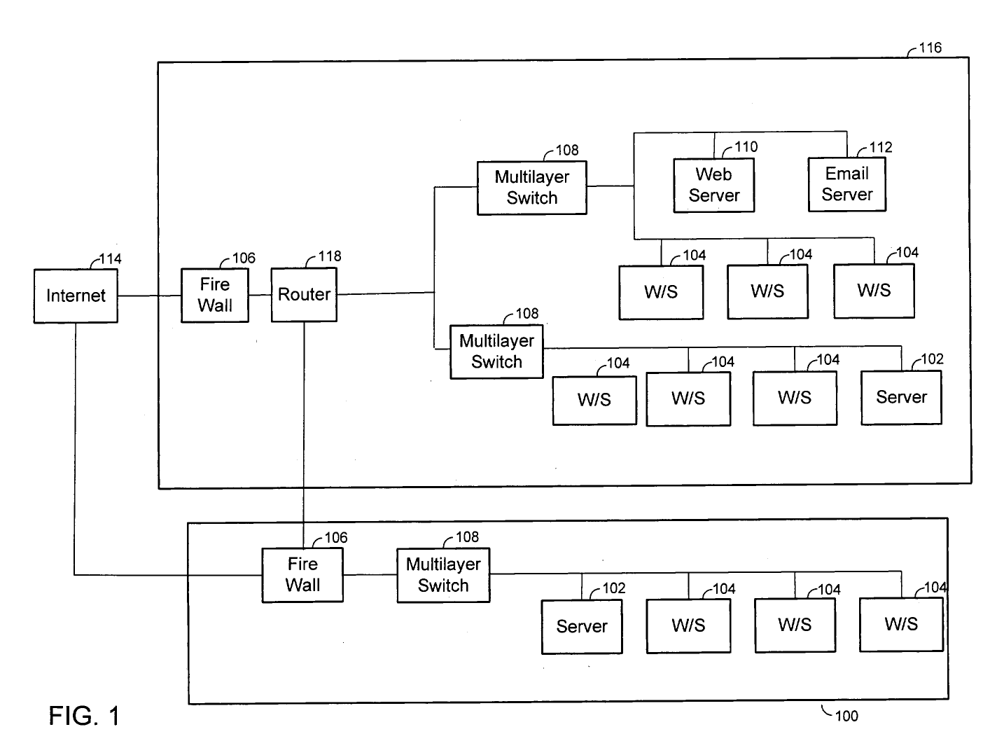

FIG. 1 shows a network topology including a local area network (LAN) 100, including a server 102, several workstations (W/S) 104, a firewall 106, and multilayer switch 108. The LAN 100 is connected to an external network, e.g., the Internet 114, through the firewall 106. The LAN 100 is also connected to a second LAN 116 through a firewall 106. Second LAN 116 includes a web server 110, an email server 112, a server 102, several workstations 104, a firewall 106 and one or more multilayer switches 108. The computers, servers and other devices in the LAN are interconnected using a number of data transmission media such as wire, fiber optics, and radio waves. Each router 118 processes Layer 3 packets and routes them through the network. The multilayer switch 108 processes and routes packets at Layer 2 and Layer 3, but modifies the routing behavior based on the processing of information contained in Layers 2 through 7 of the packet. The multilayer switch 108 processes the information in Layer 2 through 7 of the packet in an amount of time available for routing a packet at Layer 2 (wire-speed).

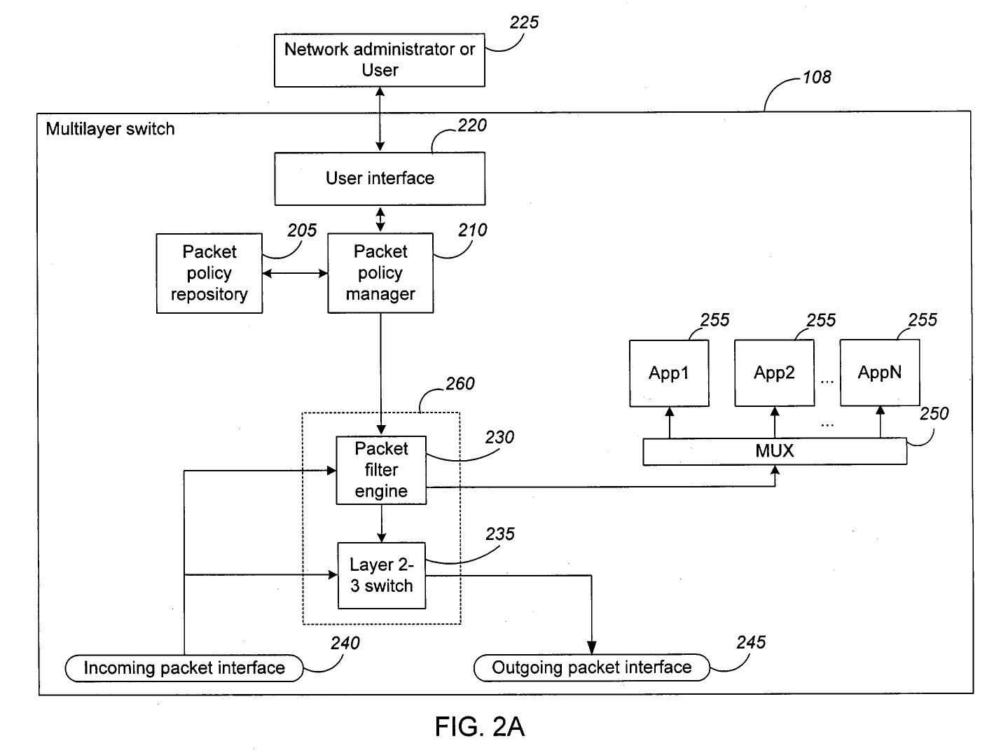

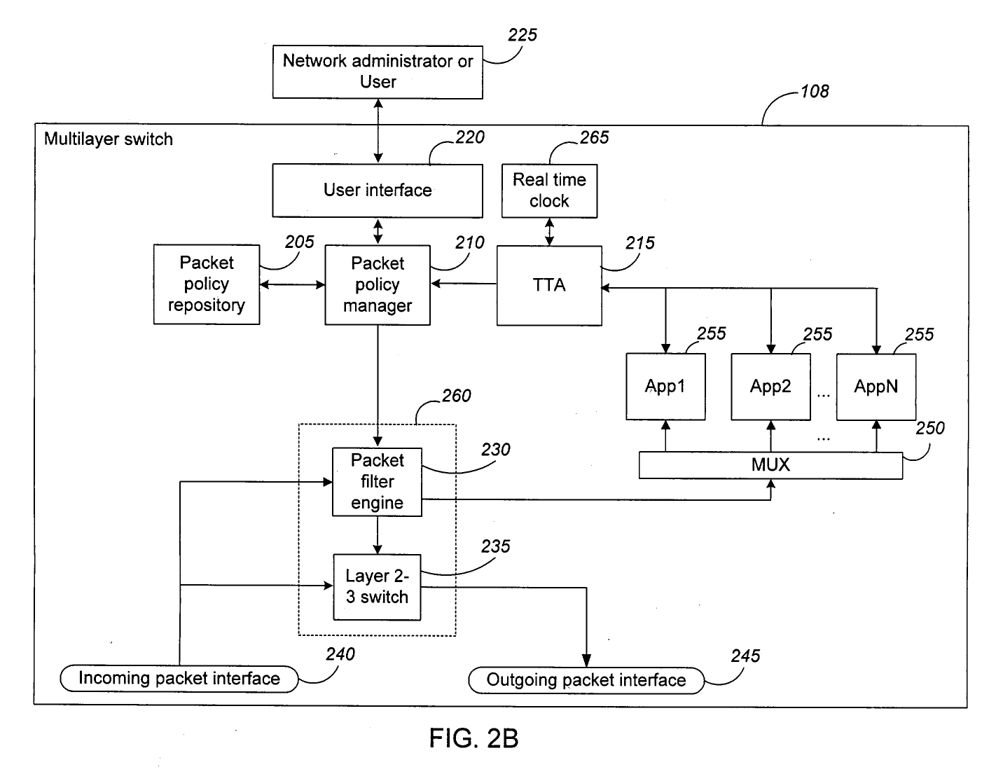

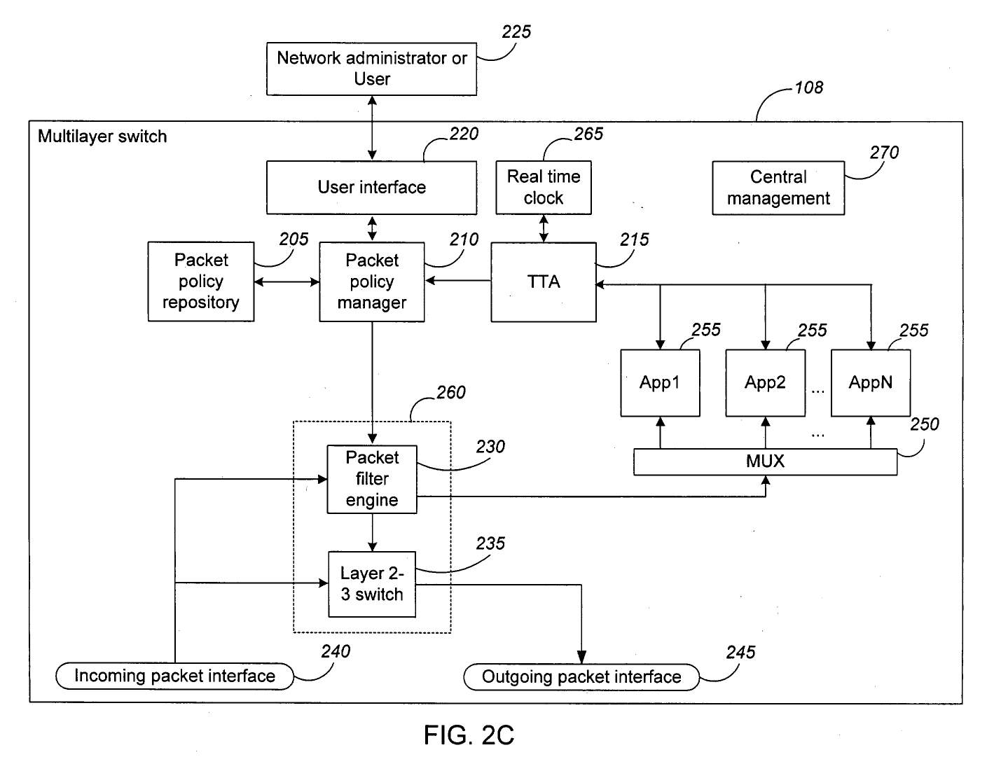

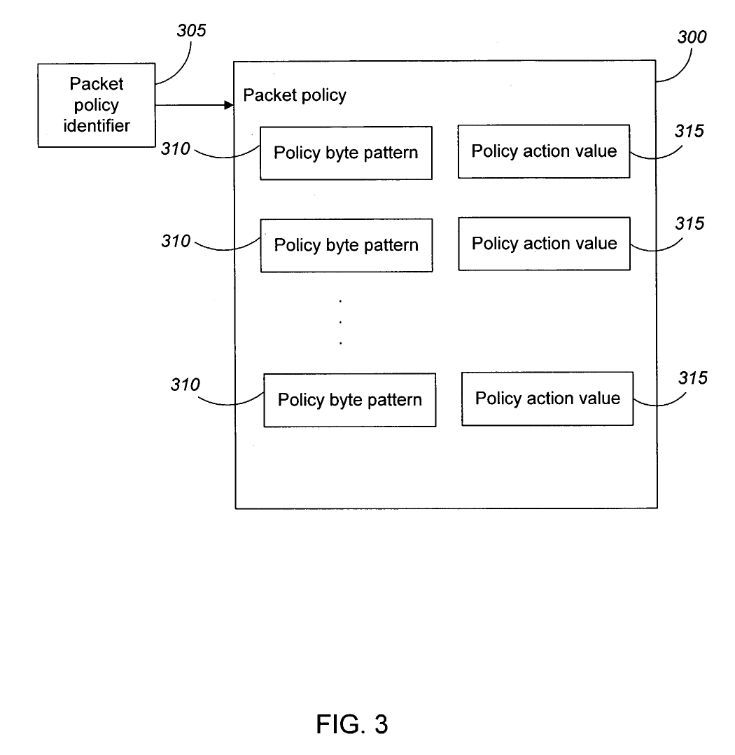

FIG. 2A shows a block diagram of an exemplary implementation of the switch 108. The switch 108 includes a packet policy manager (PPM) 210 and a packet filter engine (PFE) 230. The user or network administrator 225 interacts with the PPM 210 through the user interface 220 to specify the requested packet policies to be implemented by the switch 108. In one implementation, the switch 108 includes an HTTP server and the user interface displays a web page that can be used by the user 225 to specify the requested packet policies. The PPM stores the requested packet policies in the packet policy repository (PPR) 205. In one implementation, the PPM 210 assigns a packet policy identifier for each requested packet policy and the packet policies can be retrieved from the PPR 205 using the packet policy identifier. The PPM 210 transmits the requested packet policies to the PFE 230 in order to activate the packet policies. The PFE 230 stores the active packet policies along with the packet policy identifier for each active policy. The switch 108 receives data packets using the incoming packet interface 240. A data packet includes data being communicated in a computer network that has been packetized. A data packet also includes TCP/IP packets. The PFE 230 screens incoming data packets to determine if they match one of the requested packet policies. If the received data packet matches one of the requested packet policies, the PFE 230 can block the received data packet or modify the data packet as requested by the matching packet policy before routing. If the received data packet is not blocked by the PFE 230, it is routed by the Layer 2-3 switch 235 using the out going packet interface 245. FIG. 3 is a block diagram illustrating the components of a packet policy 300. Each packet policy 300 can have an associated packet policy identifier 305 that can be used to access the packet policy. The packet policy 300 contains a policy byte pattern 310 and one or more policy action fields 315. Each policy action field 315 can also have an associated policy action value 320. The policy action field 315 specifies the processing of the received packet including whether the received packet should be routed, blocked, redirected, or cloned. The policy action field 315 can also specify modifications to be performed on the packet before it is routed. An incoming packet matches the packet policy 300 if the incoming pattern contains a sequence of bytes identical to the policy byte pattern 310. The policy action fields 315 specify one or more actions to be performed when a matching packet is received. The policy action value 320 specifies additional optional parameters for the policy action field 315. Table I is an exemplary list of values for the policy action field 315 along with a description of the action to performed for each value.

TABLE I

| Action | Function | Action Value |
|---|---|---|
| None | No sub service is selected in this policy. | None |
| Discard | Drops packets that match this policy | None |
| Flow Meter | Regulates the percentage of 1-100 | 10/100 ports: |
| | bandwidth for packets that match this | 1 = 1 Mbps |
| | policy. The percentage is specified in the | Gigabit ports: |
| | policy action value. | 1 = 8 Mbps |
| | | Example: 5 |
| Mirror to | Mirrors packets that match this policy to | None |
| Port | the mirrored to port. Port mirroring must | |
| | be enabled on the switch. The mirror | |
| | port is specified when the switch is | |
| | configured. | |
| Redirect | Changes port of Egress for packets that | Ports 1-26, |
| | match this policy. The Egress port is | Example: 24 |
| | specified in the policy action value. | |
| Prioritize | Internally prioritizes packets that match | 0-7 |
| | this policy. The policy action value | Example: 5 |
| | specifies the priority. | |
| Do Not Drop | If a policy is created to drop a certain | None |
| | type of traffic this option can be selected | |
| | to not discard packets that match this | |
| | policy. | |
| Change | Redirects packet to a new CoS queue as | 0-7 |
| 802.1p Tag | specified by the policy action value. | Example: 3 |
| Change | Redirects packet to a new CoS queue as | 0-7 |
| IPTOS | specified by the policy action value. | Example: 3 |
| Change | Matches IPTOS to 802.1p | None |
| IPTOS to | | |
| 802.1p | | |
| IP DiffServ | Modify the IP header to insert the | 0-31 |
| | “differential services code point” (DSCP) | Example: 11 |
| | as specified by the policy action value. | |

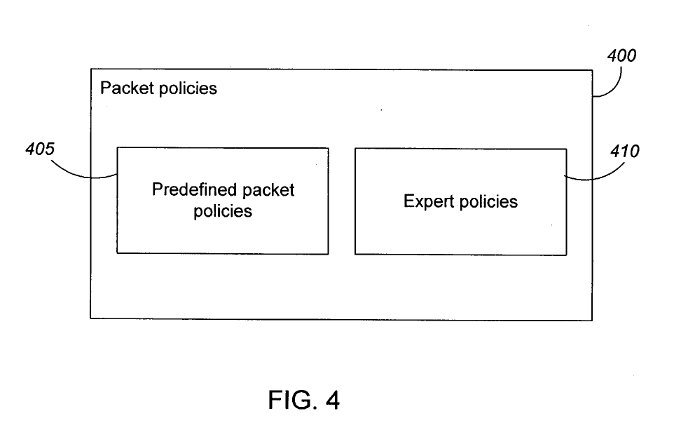

FIG. 4 is a block diagram illustrating the types of packet policies 400 that may be requested by the user. The requested packet policies can be selected from predefined packet policies 405 or expert packet policies 410. Referring to FIG. 3, expert packet policies 410 are user defined packet policies for which the user provides the policy byte pattern 310, the policy action fields 315, and the associated policy action values 320. Predefined packet policies 405 consist of packet policies that are used by a large number of users. The PPM (210, FIG. 2) provides the policy byte pattern 310 for predefined packet policies 405 and the user is not required to provide a byte pattern for these policies. The PPM 210 also provides default policy action fields 315 and policy action values 320 for each predefined packet policy 405. In one implementation, the user can customize a predefined packet policy 405 by modifying the policy action fields 315 and policy action values 320. Predefined packet policies 405 can include packet policies for commonly used applications like Yahoo Messenger, Microsoft Netmeeting, or interactive networked computer games. Predefined packet policies 405 can also include packet policies for known network security attacks like IP spoofing, and to block access to specific URLs.

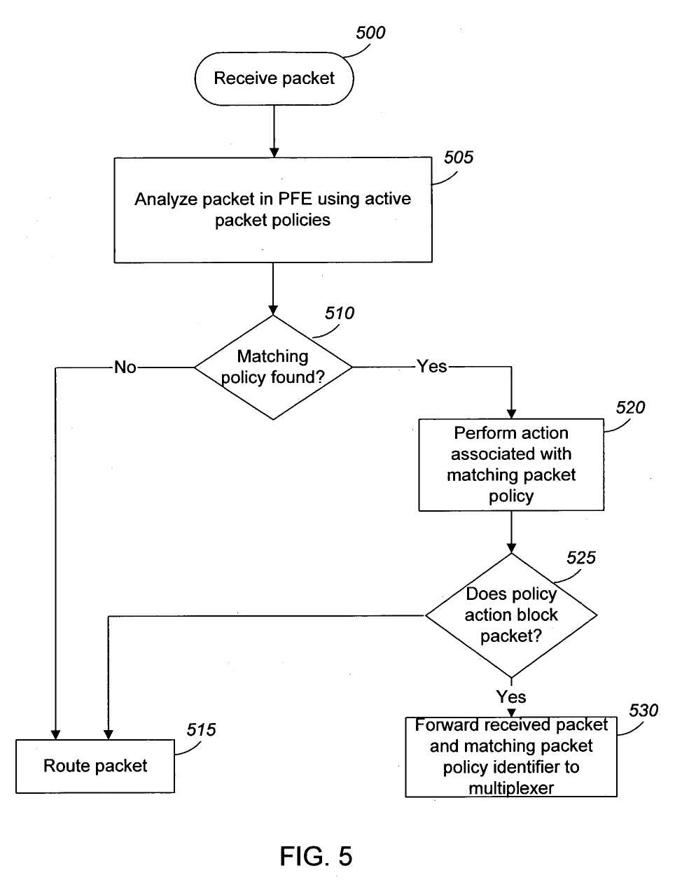

FIG. 5 is a flow diagram illustrating the method of operation of the PFE (230, FIG. 2). Incoming packets are received (step 500), and analyzed in the PFE 230 using the active packet policies (step 505). If there is no matching packet policy (“no” branch of decision step 510), the packet is routed by the Layer 2-3 switch (235, FIG. 2) (step 515). If there is a matching packet policy (“yes” branch of decision step 510), the actions specified in the policy action fields (315, FIG. 3) are performed (step 520). If the packet is not blocked by the policy action fields 315 of the matching policy (“no” branch of decision step 525), it is routed by the Layer 2-3 switch 235 (step 515). If the packet is blocked by the policy action fields 315 of the matching policy (“yes” branch of decision step 525), the blocked packet is forwarded to the multiplexer (250, FIG. 2) along with the packet policy identifier (305, FIG. 3) of the matching packet policy (step 530).

Referring to FIG. 2A, the multiplexer 250 forwards the blocked packet and the blocked policy identifier to one or more switch applications 255 running on the switch. In one implementation, the blocked packet and the associated packet policy identifier are also sent to other network devices external to the switch 108 for further processing. Switch applications 255 and external network devices can avoid analyzing the blocked packet by using the associated packet policy identifier to identify the matching policy for the blocked packet. In one exemplary embodiment of the switch 108, one of the network applications 255 can be a network address translation (NAT) application that receives and processes blocked NAT packets. In another exemplary embodiment of the switch 108, one of the network applications 255 can be a network security application that analyzes blocked packets for known attack signatures to determine if an attempted network security intrusion is in progress. The network security application can also transmit additional packet policies to the PFE 230 through the PPM 210 to block an attempted network security intrusion.

FIG. 2B is a block diagram illustrating an alternative implementation of the switch 108 including a time triggered action unit (TTA) 215. The TTA 215 allows the user to schedule timed packet policies that are used to filter incoming packets only during the specified time periods. The TTA 215 schedules the timed packet policies using a time reference obtained from a real time clock 265. The user can specify that a requested packet policy is to be used only during specified time periods. In one implementation of the switch 108, the TTA 215 is also used to schedule switch applications 255 to run during certain specified time periods.

FIG. 2C is a block diagram illustrating another implementation of the switch 108 including a central management unit (CMU) 270. As described later, the CMU 270 is used for performing firmware and configuration updates.

In one exemplary implementation of the switch 108, the PFE and the Layer 2-3 switch combination 260 can be implemented using the BCM5615 chip available from Broadcom®. The exemplary implemetation also includes a programmable processor, a random access memory (RAM), a program memory (for example, a writable read-only memory (ROM) such as a flash ROM), and non-volatile random access memory (NVRAM). The PPM 210, the TTA 215, the CMU 250, the user interface 220, the switch applications 255, and the multiplexer 250, can be implemented as a computer program running on the programmable processor. The implementation also uses a DS1554 chip available from Dallas Semiconductor® as a real time clock providing the current time. The computer program is stored in the program memory and uses the RAM during execution. The packet policy repository is implemented using the NVRAM.

Referring to the exemplary implementation of the switch 108, the user can specify the requested packet policies using a web browser implemented by the computer program. The requested packet policies are received by the computer program and stored in the NVRAM. The computer program can also assign a packet policy identifier (305, FIG. 3) for each requested packet policy and the requested packet policies can be stored in the NVRAM indexed by the packet policy identifier 305. The packet policy manager 210 implemented by the computer program transfers the packet policies from the NVRAM to the BCM5615 chip to activate the packet policies. Incoming packets are filtered by the BCM5615 chip based on the activated packet policies. If a packet is blocked, it is forwarded to the computer program for further processing by one of the switch applications 255. The user can specify timed packet policies using the user interface. For timed packet policies the TTA 215 informs the PPM 210 when a requested packet policy is required to be activated or de-activated. If the requested packet policy is to be activated, the PPM 210 transfers the requested packet policy to the BCM5615 chip to activate the packet policy. If the requested packet policy is to be deactivated, the PPM 210 transmits a request to the BCM5615 chip to delete the requested policy from the list of active policies.

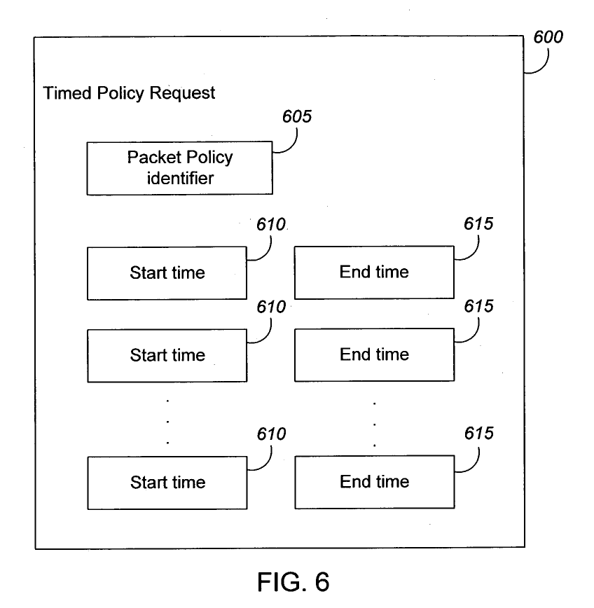

FIG. 6 is a block diagram illustrating a timed policy request 600 to be processed using the TTA (215, FIG. 2). The timed policy request 600 includes a packet policy identifier 605, and one or more pairs of start time 610 and end time 615 values. The packet policy identifier 605 identifies a policy that already been programmed by the user. The start time 610 and the end time 615 indicate the activation time and de-activation time for the policy identified by the packet policy identifier 605. If there is no end time for timed policy request 600, the policy identified by the packet policy identifier 605 is never deactivated after activation. A timed policy request 600 with no start time is used to de-activate an active policy identified by the packet policy identifier 605 at the specified end time 615. In one implementation, the timed policy request includes the packet policy to be scheduled instead of the packet policy identifier 605.

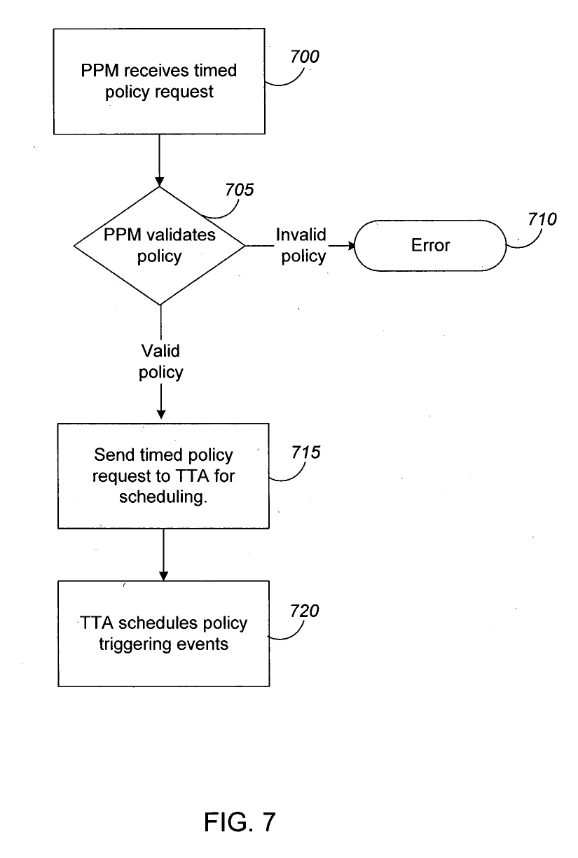

FIG. 7 is a flow diagram illustrating a method of processing a timed policy request (400, FIG. 4). Referring to FIG. 2 and FIG. 4, the PPM 210 receives a timed policy request 400 (step 700). The PPM 210 validates the timed policy request 400 by verifying that the packet policy identifier 605 identifies a packet policy that exists in the PPR 205 (step 705). If the timed policy request is invalid, an error is returned to the user (step 710). If the timed policy request is valid, the timed policy request is forwarded to the TTA 215 to be scheduled (step 715). The TTA 215 schedules a triggering event for each start time 610 and end time 615 included in the timed policy request 600 (step 720).

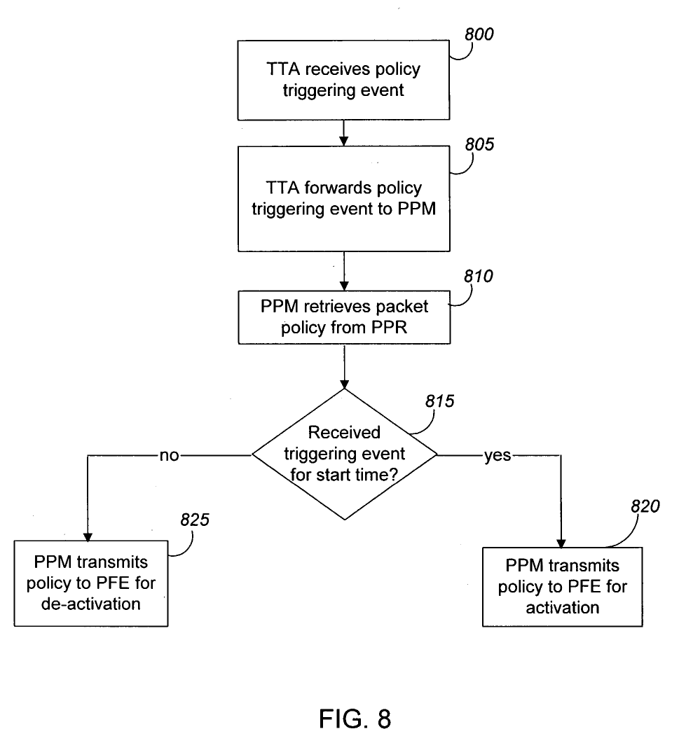

FIG. 8 is a flow diagram illustrating activation of a packet policy scheduled using a timed policy request (400, FIG. 4). Referring to FIG. 2 and FIG. 4, the TTA 215 receives a policy triggering event (step 800), and forwards the policy triggering event to the PPM 210 along with the packet policy identifier 605 associated with the triggering event (step 505). The PPM 210 retrieves the packet policy associated with the triggering event from the PPR 205 using the packet policy identifier 605 (step 810). If the received triggering event is associated with a start time 410 (“yes” branch of decision step 815), the PPM 210 transmits the retrieved policy to the PFE 230 for activation (step 820). If the received triggering event is associated with an end time 615 (“no” branch of decision step 815), the PPM transmits the retrieved packet policy to the PFE 230 for de-activation (step 825).

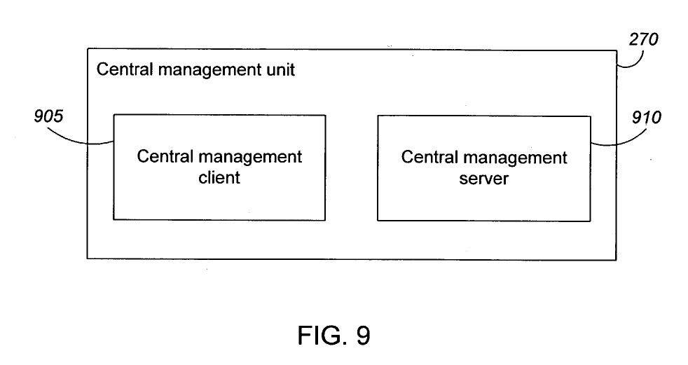

FIG. 9 is a block diagram illustrating a CMU 270. One or more network switches on the computer network can include a CMU 900. A network switch includes a switch, a router, a multilayer switch, and any other devices used to communicate data packets in a computer network. The CMU 270 includes a central management client (CMC) 905 and a central management server (CMS) 910. The CMC 905 and the CMS 910 can run at the same time. Referring to FIG. 2, the CMC 905 collects user requests from the user interface 225 through the user interface 220.

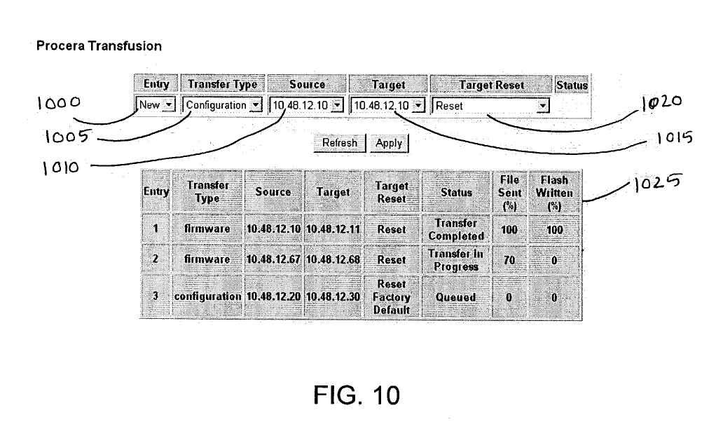

FIG. 10 illustrates an exemplary user interface for the CMU (900, FIG. 9). The user interface is operable by the user to set up data transfers between any two multilayer switches (108, FIG. 1) in the network. The user can set up a new transfer by selecting “new” for the Entry field 1000. The user can also view an existing transfer by selecting an existing entry number from the pull down menu associated with the Entry field 1000. The Transfer Type field 1005 is used to specify the type of the transfer. In one implementation the Transfer Type field 1005 values can be either “configuration” or “firmware”. Firmware updates can be performed by selecting the Transfer Type 1005 as “firmware” to set up a transfer of the firmware from one switch on the network to another switch on the network. If the selected Transfer Type 1005 is “configuration”, configuration data is transferred between switches. Configuration data includes the requested packet policies that have been specified for the switch. The Source field 1010 specified the IP address of the source switch, and the Target field 1015 specifies the IP address of the target switch for the transfer. The Target Reset field 1020 specifies the type of reset to be performed by the switch after the transfer is complete. The types of reset that can be performed include factory default reset or user specified reset. The status window 1025 displays the status of all the transfers currently in progress.

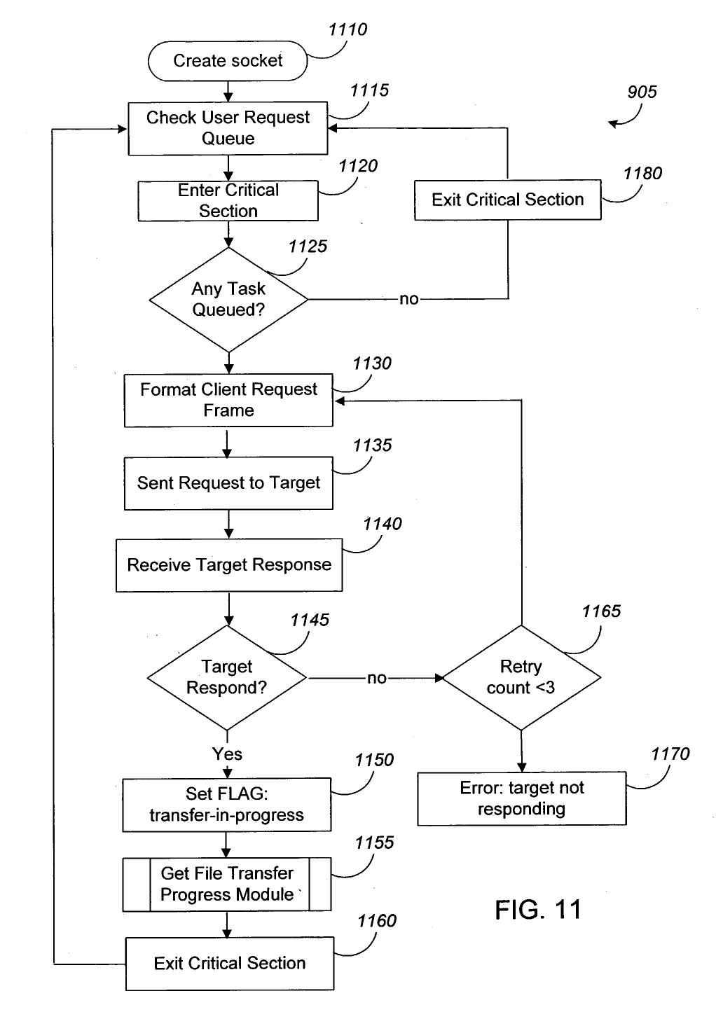

FIG. 11 is a flow diagram illustrating a method for transferring data using the CMC 905. An UDP socket is created using designated CMU port number value (step 1110). After the socket is ready for sending and receiving data to and from the CMS 910, a user request queue is checked for a queued user request task (step 1115). The critical section is entered where a data of user request queue is shared by both the CMU 900 and the user interface (220, FIG. 2) (step 1120) and a semaphore is obtained to protect the shared data from concurrent writing corruption. If there are no queued user requests, control returns to step 1115 (step 1175). If a new request is found in the queue, the client request frame is formatted (step 1130) and sent to the target specified in the request (step 1135). The client checks for a response from the target (step 1140), and if no response is received (“no” branch of decision step 1145), the client retries the request (step 1165). The client retries the request 3 times (step 1165) before signaling an error (step 1170). If a response is received from the target (“yes” branch of decision step 1145), the transfer-in-progress flag is set (step 1150), and control is transferred to the Get File Transfer Progress Module (step 1155). The Get File Transfer, Progress Module monitors the data transfer by requesting periodic status information from the target. The method exits the critical section when the file transfer is complete (step 1160).

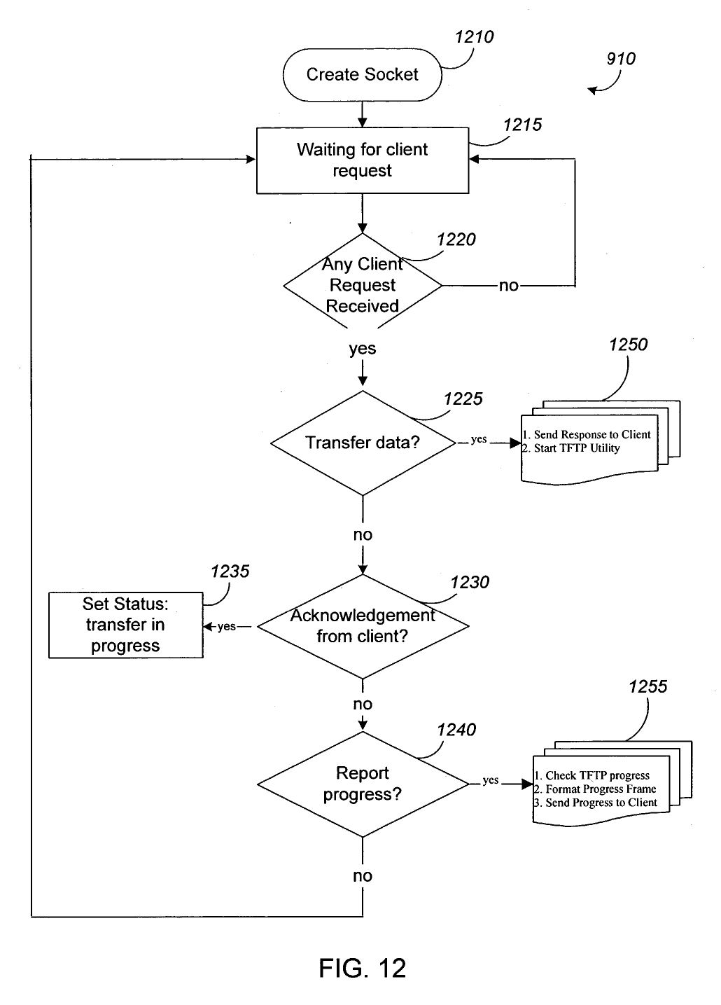

FIG. 12 is a flow diagram illustrating a method for transferring data using the CMS 910. An UDP socket is created using designated CMU port number value (step 1210). After the socket is ready for sending and receiving data to and from the CMC 910, the method waits until a client request is received (step 1215 and “no” branch of decision step 1220). If a client request is received (“yes” branch of decision step 1220), the type of the request is determined (steps 1225, 1230 and 1240). If the request type is a request to transfer data (“yes” branch of decision step 1225), the CMS 910 sends a response to the client and invokes the TFTP utility to start the data transfer (step 1250). If the request type is an acknowledgement from the client (“yes” branch of decision step 1230), the CMS 910 sets the Transfer In Progress flag (step 1235). If the request type is a request to report progress on the transfer (“yes” branch of decision step 1240), the CMS 910 checks the progress of the TFTP transfer to determine the percentage of the transfer that has been completed, formats the progress frame and sends the progress frame to the client (step 1255). After the client request has been processed control returns to step 1215.

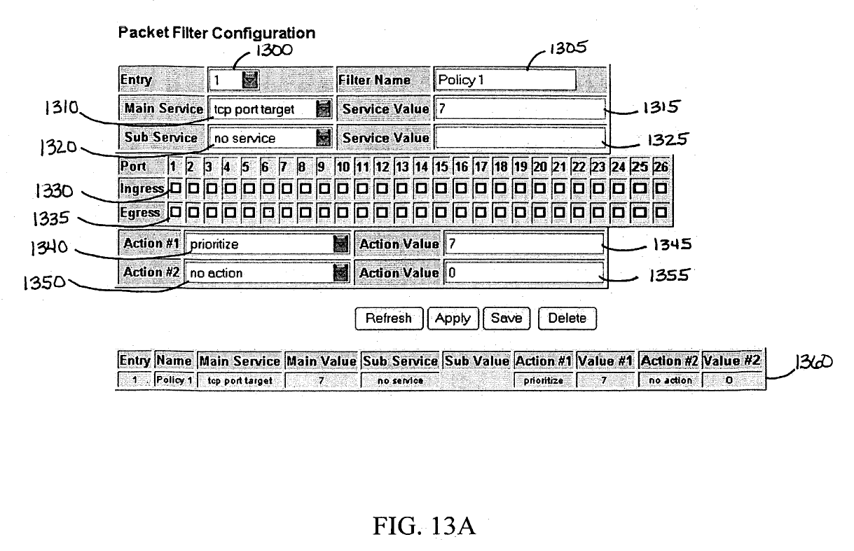

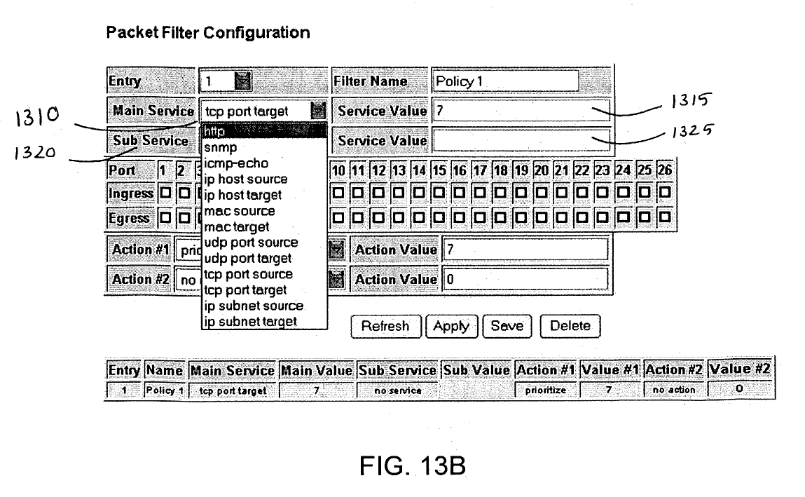

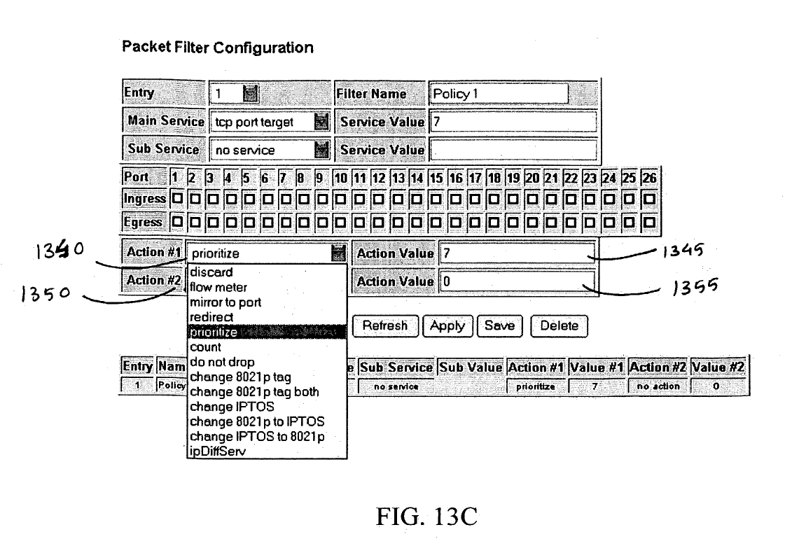

FIG. 13A illustrates an exemplary user interface operable by the user to specify requested packet policies to be implemented by the switch 108. Referring to FIG. 3, the user is prompted with a value for the entry field 1300 from a list of available packet policy identifiers 305. The user can select a value for the entry field 1300 from the list of available packet policy identifiers 305. The user provides a name for the packet policy using the filter name field 1305. The user can view a requested packet policy that has been specified by entering the packet policy identifier 305 in the entry field 1300 or by entering the name for the packet policy in the filter name field 1305. In this example, the user can specify two policy action fields 315 for each packet policy using Action #1 1340 and Action #2 1350. The policy action value 320 for Action #1 1340 is Action Value 1345, and the policy action value 320 for Action #2 1350 is Action Value 1355. The status window 1360 displays a list of packet policies that have been specified by the user. The user can also specify one or more ingress ports 1330 and one or more egress ports 1335 to indicate that the requested policy should only be applied to packets arriving on the specified ingress port 1330 or routed to the specified egress port 1335.

FIG. 13B illustrates the use of the main service menu 1310 to specify the type of packets to be filtered using the requested packet policy. In this example, the user can select from http, snmp, icmp echo, ip host source, ip host target, mac source, mac target, udp port source, udp port target, tcp port source, tcp port target, tcp port, ip subnet source, ip subnet target. The user can also specify a second type of packet to be filtered using the sub service menu 1320. The options available in the sub service menu 1320 are identical to the main service menu 1310. Additional parameters for the main service menu 1310 and the sub service menu 1320 are provided using the service value fields 1315 and 1325 respectively.

FIG. 13C illustrates the use of the action value fields Action #1 1340 and Action #2 1350 to specify the policy action field for the selected service. The policy action fields in the menu for Action #1 1340 and Action #2 1350 are described in Table I.

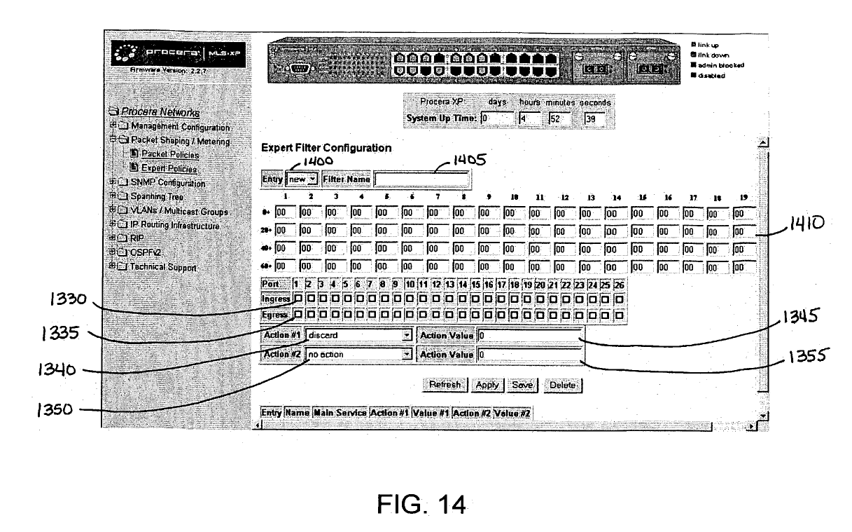

FIG. 14 illustrates an exemplary user interface operable by the user to specify expert packet policies to be implemented by the switch 108. The entry field 1400 should be selected to display “new” when the user is adding a new expert policy (410, FIG. 4). The user can edit an existing expert policy 410 by selecting the corresponding policy number from the pull down menu associated with the entry field 1400. The filter name field 1405 is used to provide a name for the expert policy 410 being added. In this example, expert policies can be defined to filter incoming packets based on the first 80 bytes of the packet. The byte table 1410 contains a field for each byte of the 80 bytes used to filter a packet. The user defines an expert filter 410 by entering the desired values for the bytes in the byte field 1410.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. The switch can be built as single or multiple rack units such as chassis and blade configuration with management and ingress/egress port blade and communication via backplane. An embodiment of the switch can support data throughput speeds of 10 megabit per second to 40 gigabit per second. The switch can be used in both wired and wireless applications to deliver voice, data, internet, and video services.

What is claimed is:

1. A method for processing data packets in a computer network, the data packets including information from one or more of Layers 2 through 7 of the OSI Model, comprising:
configuring a packet filter engine to process data packets at wire-speed based on one or more user defined packet policies, each user defined packet policy specifying information for one or more of Layers 4 through 7;
receiving a data packet, the received data packet having a sequence of bytes;
examining the data packet;
determining if there is a match between the data packet and one or more of the packet policies, each packet policy having on or more policy action fields;
if no matching packet policy is found, routing the data packet;
if a matching packet policy is found, processing the data packet based on the policy action fields of the matching policy.

2. The method of claim 1, wherein configuring the packet filter engine includes:
receiving a user request for a packet policy; and
transmitting the requested packet policy to the packet filter engine as one of the one or more user defined packet policies.

3. The method of claim 1, wherein each user defined packet policy specifies a policy byte pattern and determining if there is a match includes:
determining if the sequence of bytes in the received packet matches the policy byte pattern.

4. The method of claim 1, wherein routing the packet includes:
routing the packet using a Layer 2-3 switch.

5. The method of claim 1, wherein the policy action field specifies an action to be performed on the received data packet and processing the packet includes:
performing the specified action in the policy action field.

6. The method of claim 1, wherein processing the packet includes:
blocking the packet, based on the policy action field of the matching policy;
forwarding the data packet to one or more switch applications; and
processing the data packet using a switch application of the one or more switch applications.

7. The method of claim 6, wherein the switch applications include:
an application for performing network address translation.

8. The method of claim 6, wherein the switch applications include:
an application for detecting attempted network security attacks.

9. The method of claim 1, wherein the packet policies include:
predefined packet policies.

10. The method of claim 1, wherein the packet policies include:
expert policies specified by the user.

11. The method of claim 1, further comprising:
receiving a user request to disable a deactivated packet policy of the one or more user defined packet policies; and
configuring the packet filter engine to disable the deactivated packet policy.

12. The method of claim 1, further comprising:
specifying for one or more of the packet policies, at least one of a start time and an end time;
obtaining a current time; and
if a start time and an end time are specified, determining if there is a match includes determining if there is a match when the current time is within a duration starting at the start time and ending at the end time.

13. The method of claim 12, wherein:
if the end time is not specified, determining if there is a match includes determining if there is a match when the current time is greater than the start time.

14. The method of claim 12, wherein:
if the start time is not specified, determining if there is a match includes determining if there is a match when the current time is less than the end time.

15. A computer implemented method, comprising:
receiving a request at a first network switch to transfer switch data from the first network switch to a second network switch, the switch data being operable to control operation of the first network switch and the second network switch; and
transferring the switch data from the first network switch to the second network switch.

16. The method of claim 15, wherein the switch data includes:
configuration data operable to configure the first network switch and the second network switch.

17. The method of claim 15, wherein the switch data includes:
firmware operable to control the operation of the first network switch and the second network switch.

18. A computer program product tangibly embodied in an information carrier, the computer program product comprising instructions operable to cause data processing equipment to:
configure a packet filter engine to process data packets at wire-speed based on one or more user defined packet policies, each user defined packet policy specifying information for one or more of Layers 4 through 7;
receive a data packet, the received data packet having a sequence of bytes;
examine the data packet;
determine if there is a match between the data packet and one or more of the packet policies, each packet policy having on or more policy action fields;
if no matching packet policy is found, route the data packet;
if a matching packet policy is found, process the data packet based on the policy action fields of the matching policy.

19. The computer program product of claim 18, wherein the instructions for configuring the packet filter engine cause the data processing equipment to:
receive a user request for a packet policy; and
transmit the requested packet policy to the packet filter engine as one of the one or more user defined packet policies.

20. The computer program product of claim 18, wherein each user defined packet policy specifies a policy byte pattern and the instructions for determining if there is a match cause the data processing equipment to:
determine if the sequence of bytes in the received packet matches the policy byte pattern.

21. The computer program product of claim 18, wherein the instructions for routing the packet cause the data processing equipment to:
route the packet using a Layer 2-3 switch.

22. The computer program product of claim 18, wherein the policy action field specifies an action to be performed on the received data packet and the instructions for processing the packet cause the data processing equipment to:
perform the specified action in the policy action field.

23. The computer program product claim 18, wherein the instructions for processing the packet cause the data processing equipment to:
block the packet, based on the policy action field of the matching policy;
forward the data packet to one or more switch applications; and
process the data packet using a switch application of the one or more switch applications.

24. The computer program product of claim 23, wherein the switch applications include:
an application to perform network address translation.

25. The computer program product of claim 23, wherein the switch applications include:
an application to detect attempted network security attacks.

26. The computer program product of claim 18, wherein the packet policies include:
predefined packet policies.

27. The computer program product of claim 18, wherein the packet policies include:
expert policies specified by the user.

28. The computer program product of claim 18, further comprising instructions operable to cause the data processing equipment to:
receive a user request to disable a deactivated packet policy of the one or more user defined packet policies; and
configure the packet filter engine to disable the deactivated packet policy.

29. The computer program product of claim 18, further comprising instructions operable to cause the data processing equipment to:
specify for one or more of the packet policies, at least one of a start time and an end time;
obtain a current time; and
if a start time and an end time are specified, the instructions for determining if there is a match cause the data processing equipment to determine if there is a match when the current time is within a duration starting at the start time and ending at the end time.

30. The computer program product of claim 29, wherein:
if the end time is not specified, the instructions for determining if there is a match cause the data processing equipment to determine if there is a match when the current time is greater than the start time.

31. The computer program product of claim 29, wherein:
if the start time is not specified, the instructions for determining if there is a match cause the data processing equipment to determine if there is a match when the current time is less than the end time.

32. A computer program product tangibly embodied in an information carrier, the computer program product comprising instructions operable to cause data processing equipment to:
receive a request at a first network switch to transfer switch data from the first network switch to a second network switch, the switch data being operable to control operation of the first network switch and the second network switch; and
transfer the switch data from the first network switch to the second network switch.

33. The computer program product of claim 32, wherein the switch data includes:
configuration data operable to configure the first network switch and the second network switch.

34. The computer program product of claim 32, wherein the switch data includes:
firmware operable to control the operation of the first network switch and the second network switch.

35. An apparatus for processing data packets, comprising:
a packet policy repository containing one or more requested packet policies, each requested packet policy having a policy byte pattern and one or more policy action fields;
a time triggered action unit operable to specify at least one of a start time and an end time associated with a requested packet policy of the one or more requested packet policies, generate a start time trigger event if the start time is specified, generate an end time trigger event if the end time is specified;
a packet filter engine that applies one or more activated packet policies for each received packet, the packet filter engine operating at wire-speed, the packet filter engine being operable to detect received packets matching an activated packet policy of the one or more activated packet policies, and process the packet according to the policy action fields of the matching packet policy; and
a packet policy manager, the packet policy manager detecting the start time trigger event and adding the associated requested packet policy to the one or more activated packet policies applied by the packet filter engine, the packet policy manager detecting the end time trigger event and deleting the associated requested packet policy from the one or more activated packet policies applied by the packet filter engine.

36. The apparatus of claim 35, wherein:
the packet policy manager is operable by the user to specify one or more user defined packet policies, the user defined packet policies being stored as requested packet policies in the packet policy repository.

37. An apparatus for processing data packets, comprising:
a plurality of network switches, each network switch including a central management unit, the central management unit including a central management client and a central management server;
a first network switch being operable to transfer data from the first network switch to a second network switch;
a third network switch being operable to receive requests from the user for a transfer of switch data from the first network switch to the second network switch, the third network switch configuring the first network switch and the second network switch to complete the transfer of data requested by the user, the switch data being operable to control the operation of the first network switch and the second network switch.

38. The apparatus of claim 37, wherein the switch data includes:
configuration data being operable to configure the first device and the second device.

39. The apparatus of claim 37, wherein the switch data includes:
firmware operable to control the operation of the first network switch and the second network switch.
